(19) United States
(12) Patent Application Publication
(10) Pub. No.: US 2017/0051580 A1
(43) Pub. Date: Feb. 23, 2017

(54) HYDROCARBON POWER SYSTEM

(71) Applicant: GEOTEK ENERGY, LLC, Midland, TX (US)

(72) Inventors: Michael Pierce, Erie, CO (US); Allen Swenson, Frisco, TX (US); Angel Sanchez, Plano, TX (US); Blake Sellers, Frisco, TX (US)

(21) Appl. No.: 15/234,882

(22) Filed: Aug. 11, 2016

Related U.S. Application Data
(60) Provisional application No. 62/206,528, filed on Aug. 18, 2015.

(51) Int. Cl. E21B 41/00; F01D 25/16; F01D 5/02; F01D 25/24; E21B 36/00; E21B 43/12

(52) U.S. Cl. CPC E21B 41/0085; E21B 36/006; E21B 43/121; F01D 5/02; F01D 25/24; F01D 25/16; F05D 2240/60

(57) ABSTRACT

A hydrocarbon power system that includes a turbine generator, a downhole heat exchanger, and an expander pump assembly. Various arrangements of the expander pump assembly address considerations related to the design of the downhole expander pump. In such a system, the turbine generator receives a high pressure working fluid from the downhole system to drive a generator. The turbine generator can be in fluid communication with the downhole heat exchanger and with the turbine portion of a downhole turbine pump assembly. The pump portion of the downhole turbine pump assembly can be in fluid communication with the downhole heat exchanger and a source of hydrocarbon fluid.

### CROSS REFERENCE TO RELATED APPLICATION

The current application claims priority to and the benefit of co-pending U.S. Provisional Patent Application Ser. No. 62/206,528 filed on Aug. 18, 2015, entitled “HYDROCARBON POWER SYSTEM”. This reference is incorporated in its entirety herein.

### FIELD

The present embodiments generally relate to a hydrocarbon power system for hydrocarbon wells.

### BACKGROUND

A need exists for a hydrocarbon fluid flow based robust downhole turbine adapted for a downhole operating environment for driving a surface mounted generator, compressor and separator.

The present embodiments meet these needs.

### BRIEF DESCRIPTION OF THE FIGURES

The detailed description will be better understood in conjunction with the accompanying drawings as follows:

FIG. 1A is a schematic diagram of a hydrocarbon power system according to one or more embodiments.

FIG. 1B is a detailed schematic diagram of the hydrocarbon power system shown in FIG. 1A according to one or more embodiments.

FIG. 1C is a process flow diagram of the hydrocarbon power system according to one or more embodiments.

FIGS. 2 and 3 show the states of the working fluid in a working fluid loop according to one or more embodiments.

FIG. 4A shows a cutaway view of a hydrocarbon fluid pump according to one or more embodiments.

FIG. 4B shows a sectional view through the hydrocarbon fluid pump of FIG. 4A according to one or more embodiments.

FIG. 5A shows a sectional view of the downhole turbine according to one or more embodiments.

FIG. 5B shows a side elevational view of the downhole turbine shown in FIG. 5A according to one or more embodiments.

FIG. 5C shows fluid pathways of the downhole turbine according to one or more embodiments.

FIG. 6 shows a magnetic coupling according to one or more embodiments.

FIG. 7 is a cross sectional view of the downhole turbine according to one or more embodiments.

The present embodiments are detailed below with reference to the listed Figures.

### DETAILED DESCRIPTION OF THE EMBODIMENTS

Before explaining the present system in detail, it is to be understood that the system is not limited to the particular embodiments and that it can be practiced or carried out in various ways.

The present embodiments generally relate to a hydrocarbon power system for hydrocarbon wells.

The present embodiments further relate to subsurface equipment for hydrocarbon power systems and more particularly to a downhole turbine.

In one aspect of the invention, the hydrocarbon power system can include a power plant fluidly connected to a downhole heat exchanger which can fluidly engage an expander pump unit that can provide working fluid to the power plant.

The power plant can be structured to receive the working fluid and to drive at least one surface located electric generator at the surface, a surface located pump, or a surface located compressor.

The downhole heat exchanger can be structured to transfer heat from an upwardly directed hydrocarbon fluid to the working fluid.

In embodiments, the expander pump unit can include the downhole turbine coupled to the hydrocarbon fluid pump using the magnetic coupling.

In embodiments, the expander pump unit can be removably disposed downhole in a wellbore inside a well casing.

The hydrocarbon fluid pump can be in fluid communication with the downhole heat exchanger and a source of the upwardly directed hydrocarbon fluid from a reservoir in a formation.

The downhole turbine can be in fluid communication with the downhole heat exchanger and the surface located in the power plant so as to receive the working fluid from the power plant. The power plant can direct the flow of the working fluid through the downhole turbine, the downhole heat exchanger and the hydrocarbon fluid pump and return the working fluid to the power plant in a recycle loop.

The downhole turbine can include a turbine casing, a turbine shaft rotatably supported by the turbine casing and coaxial with a hydrocarbon well.

In embodiments, a rotor can be coupled to the turbine shaft.

The rotor can be structured to receive the working fluid from the downhole heat exchanger and to redirect the working fluid to flow in opposed axial directions.

The downhole turbine can also include a plurality of bearings supporting the turbine shaft. The plurality of bearings can be disposed between the turbine shaft and the turbine casing, and the plurality of bearings can be simultaneously lubricated by the working fluid.

A radial circumferential inlet can be formed through the turbine casing, with the radial circumferential inlet being constructed to direct the working fluid to the rotor.

The turbine shaft can be constructed to direct the working fluid redirected by the rotor in an outlet direction towards the surface of the power plant.

In another aspect of the invention, the expander pump unit for the hydrocarbon power system is provided.

The expander pump unit can have the hydrocarbon fluid pump magnetically coupled to the downhole turbine. The hydrocarbon fluid pump can pump the upwardly directed hydrocarbon fluid upward from a source of hydrocarbon fluid in a reservoir.

In another aspect of the invention, the downhole turbine is provided.

The downhole turbine can include the turbine casing, a turbine shaft rotatably coupled to the turbine casing, and a plurality of bearings between the turbine casing and the turbine shaft for supporting the turbine shaft in the turbine casing.

The plurality of bearings can be lubricated by the working fluid.

The downhole turbine can also include the rotor coupled to the turbine shaft.

The radial circumferential inlet can be formed around the rotor and can be constructed for delivering the working fluid to the rotor.

The rotor can be constructed to redirect the working fluid received from the radial circumferential inlet in at least two opposed axial directions. Moreover, the turbine shaft can be constructed to direct the working fluid redirected by the rotor in an outlet direction toward the surface and out of the hydrocarbon well.

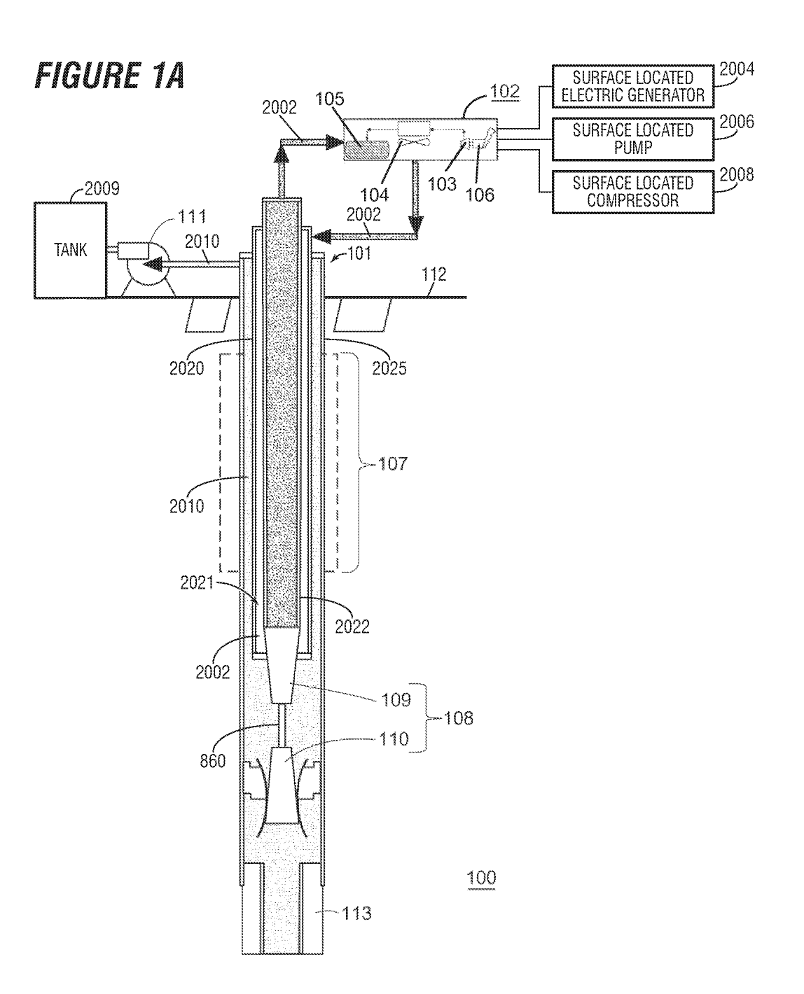

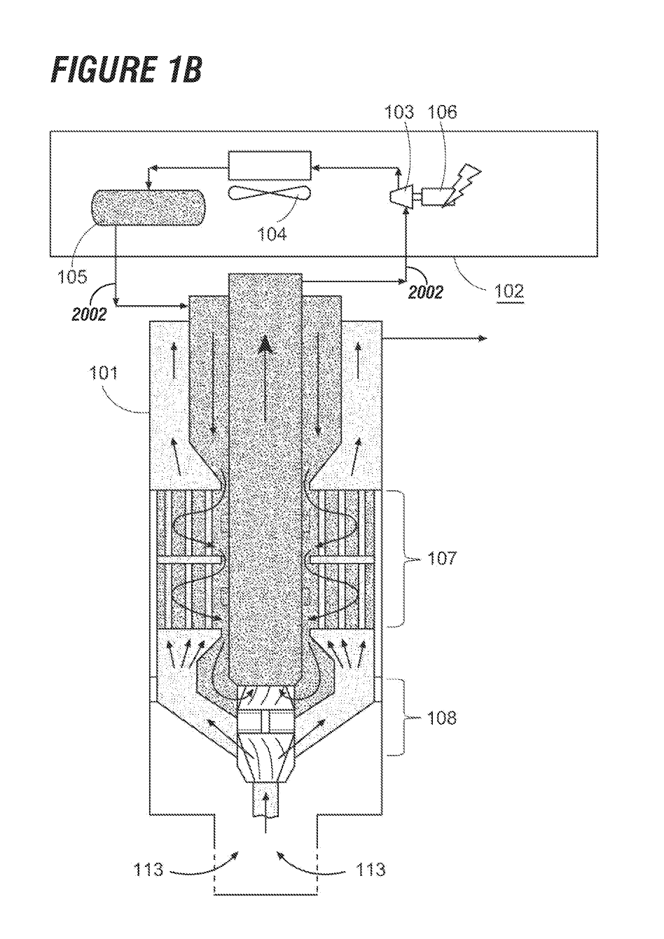

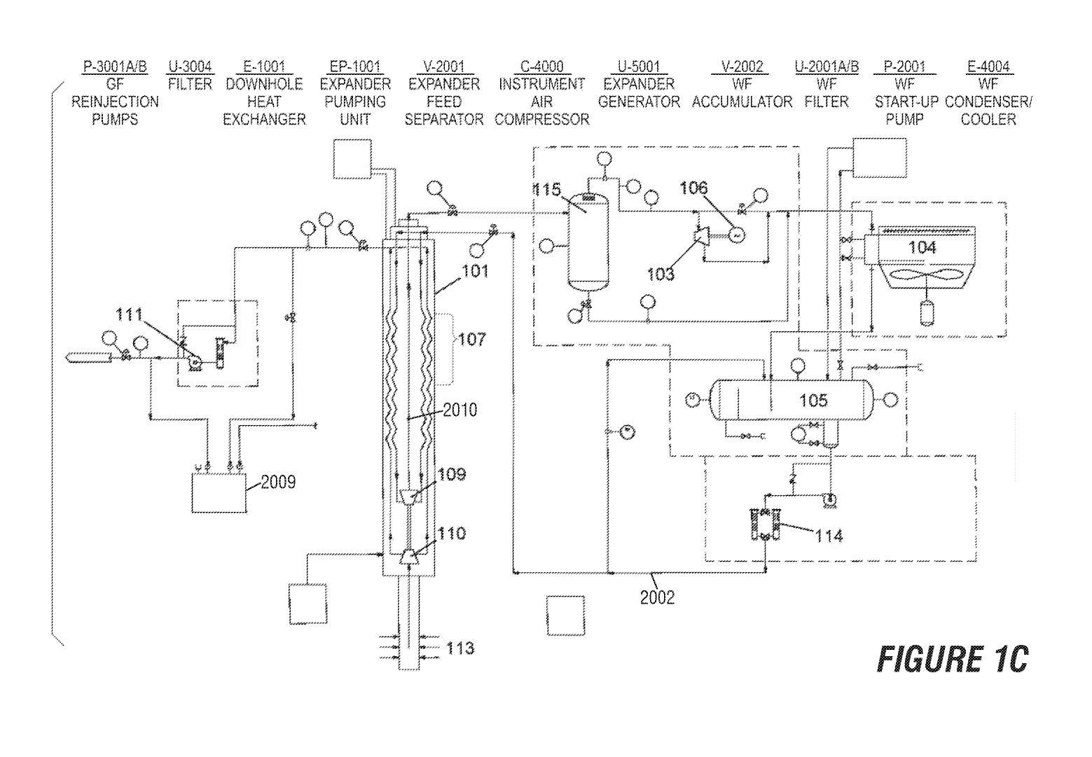

Turning now to the Figures, FIG. 1A is a schematic diagram of the hydrocarbon power system according to one more embodiments. FIG. 1B a detailed schematic diagram of the hydrocarbon power system shown in FIG. 1A according to one or more embodiments. FIG. 1C is a process flow diagram of the hydrocarbon power system according to one or more embodiments.

Referring to FIGS. 1A-1C, the hydrocarbon power system 100 can include components located above and below a surface 112 in a hydrocarbon well 101.

A power plant 102 can be located above the surface 112 of the hydrocarbon well 101 of the hydrocarbon power system 100.

The power plant 102 can include a generating turbine 103, which can be in fluid communication with a condenser 104 and an accumulator 105.

The generating turbine 103 can drive at least one surface located electric generator 2004, a surface located pump 2006, and a surface located compressor 2008.

Above ground, the power plant 102 can have the generating turbine 103, the condenser 104, the accumulator 105 and the at least one surface located electric generator 106.

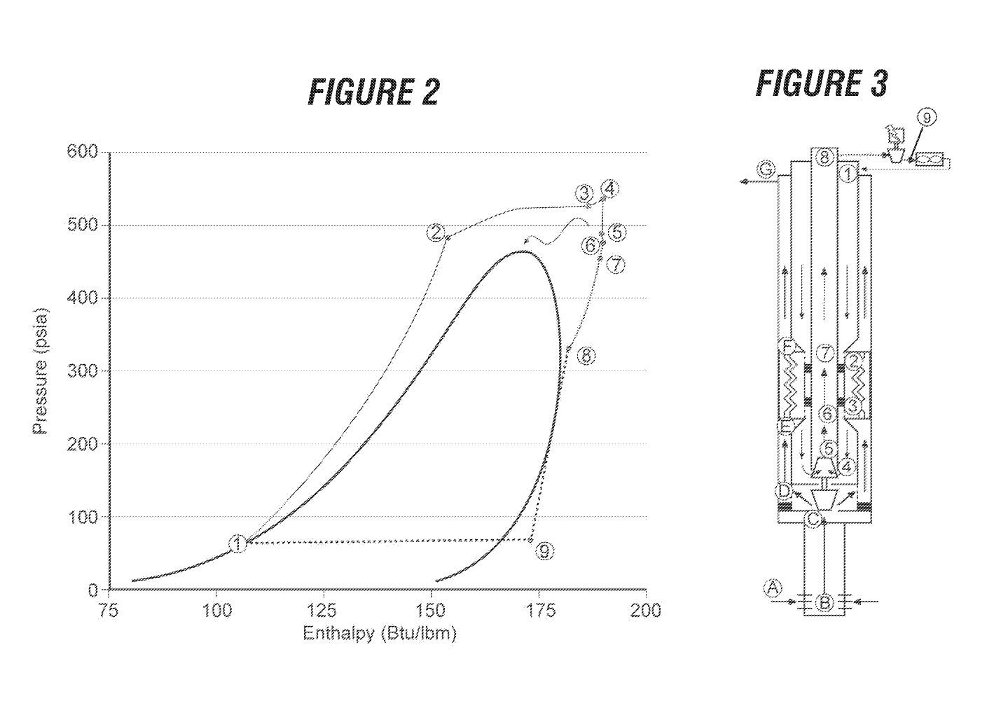

The power plant 102 can communicate with a downhole heat exchanger 107 and a downhole turbine 109. The power plant can pass a working fluid 2002 between the downhole heat exchanger 107 and the downhole turbine 109, which can complete a thermodynamic cycle described herein with reference to the state diagram shown in FIG. 2 and the schematic shown in FIG. 3.

In embodiments, an expander pump unit 108 can be below the surface 112 of the hydrocarbon well 101 the hydrocarbon power system 100.

The expander pump unit 108 can include the downhole turbine 109 coupled to a hydrocarbon fluid pump 110.

The working fluid 2002 of the thermodynamic cycle can be a hydrocarbon alkane or a hydrofluorocarbon refrigerant, such as, for example, HFC236fa and HFC-245fa.

The hydrocarbon fluid pump 110 can be in fluid communication with a pump 111 at the surface 112 of the hydrocarbon well 101 for flowing or direct the flow of an upwardly directed hydrocarbon fluid 2010 from a reservoir to a tank 2009.

Throughout the hydrocarbon well, including the downhole heat exchanger, the working fluid 2002 and the upwardly directed hydrocarbon fluid 2010 can flow in separate flow channels to avoid mixing the two fluids.

The hydrocarbon fluid pump 110 can transfer heated upwardly directed hydrocarbon fluid from a production zone 113 upwards through the downhole heat exchanger 107 to the surface 112, which then can be introduced to the tank 2009.

The pipe-in-pipe-in-well casing configuration is shown in embodiments.

The hydrocarbon well 101 can comprise a well casing 2025. Inside the well casing 2025 can be an outer pipe 2020. Inside the outer pipe 2020 can be an inner pipe 2022.

An annular space 2021 can be formed between the inner pipe 2022 and the outer pipe 2020 for the working fluid 2002.

A magnetic coupling 860 can couple the downhole turbine 109 to the hydrocarbon fluid pump 110.

The working fluid 2002 can be shown recycling to the power plant 102.

The power plant 102 can be shown with the generating turbine 103, the condenser 104, and the accumulator 105 for powering the at least one surface located electric generator 106.

In embodiments, the working fluid 2002 can enter the power plant 102 and recycle to the hydrocarbon well 101.

The hydrocarbon well 101 can be shown with the downhole heat exchanger 107 and the expander pump unit 108.

The production zone 113 can surround the base of the hydrocarbon well 101. Arrows show an embodiment of the upwardly directed hydrocarbon fluid 2010.

The working fluid 2002 from the accumulator 105 can flow or can be pumped through filters 114 before the working fluid 2002 can be introduced down the hydrocarbon well 101.

The working fluid 2002 can travel down the hydrocarbon well 101 through the downhole heat exchanger 107 to the downhole turbine 109. The working fluid 2002 can expand through the downhole turbine 109 and exit the hydrocarbon well at the surface 112 where it can then enter an expander feed separator 115.

From the expander feed separator 115, the working fluid 2002 can move to the generating turbine 103 where the working fluid 2002 can expand and then enter the condenser 104. The working fluid 2002 can exit the condenser 104 and flow back to the accumulator 105 completing a cycle in the closed working fluid loop.

The working fluid can be expanded through the generating turbine 103 to drive the at least one surface located electric generator 106. The pressure of the working fluid 2002 can be lowered at an exit of the generating turbine 103.

From the hydrocarbon well 101, the upwardly directed hydrocarbon fluid 2010 can flow to the pump 111 for storage in the tank 2009 or for flowing into another pipeline.

FIGS. 2 and 3 show the states of the working fluid in a working fluid loop according to one or more embodiments.

As shown with reference to FIG. 2 and FIG. 3, the states of the working fluid in the working fluid loop shown in FIG. 3 are numbered 1 to 9.

At state 1, the working fluid 2002 can be a liquid. In moving to state 2, the working fluid 2002 can flow down the upper section of the hydrocarbon well 101 resulting in a pressure increase of the working fluid 2002. As the upwardly directed hydrocarbon fluid rises to the surface 112, heat can be transferred from the upwardly directed hydrocarbon fluid 2010 to the working fluid 2002, which can elevate the temperature of the working fluid 2002 at state 2.

In moving from state 2 to state 3, the working fluid 2002 can be heated by the upwardly directed hydrocarbon fluid 2010 in the downhole heat exchanger 107, while pressure increase can be minimal.

In moving to state 4, below the downhole heat exchanger 107, the pressure of the working fluid 2002 can be increased, accompanied by heat transfer from the rising upwardly directed hydrocarbon fluid 2010.

As a result of the pressure and temperature changes, at state 4 the working fluid 2002 can be in a supercritical state. In one example, the pressure of the working fluid 2002 at state 4 can be 573 pounds per square inch absolute and the temperature can be 302 degrees Fahrenheit.

In state 5, the working fluid 2002 can be expanded isentropically across the downhole turbine 109 of the expander pump unit 108. This isentropic expansion can provide energy to drive the hydrocarbon fluid pump 110.

Continuing with the example at state 4, the pressure at state 5 can be 526 pounds per square inch absolute.

As the working fluid 2002 rises toward the surface 112, the working fluid 2002 can pass through states 6 to 8 where the working fluid (with reduced density) can flow to the surface 112, returning as a vapor at state 8.

The working fluid 2002 can be expanded through the generating turbine 103 to drive the at least one surface located electric generator 106. The pressure of the working fluid 2002 can be lowered at the exit of the generating turbine 103 at state 9.

Thereafter, the working fluid can be passed through the condenser 104 and can be cooled. The working fluid 2002 can return to a liquid at state 1, whereupon the working fluid 2002 can be reintroduced to the hydrocarbon well 101.

Also, in FIGS. 2 and 3 the states of the hydrocarbon fluid are labeled A to G.

In state A, the upwardly directed hydrocarbon fluid 2010 in the production zone 113 can surround the base of the hydrocarbon well 101. The upwardly directed hydrocarbon fluid 2010 can be expected to be at a temperature from 250 degrees Fahrenheit to 425 degrees Fahrenheit.

At state B, the upwardly directed hydrocarbon fluid 2010 can enter the hydrocarbon well 101 and flow up to the hydrocarbon fluid pump 110 intake at state C.

The upwardly directed hydrocarbon fluid 2010 can be transported axially by the hydrocarbon fluid pump 110 to state D.

The hydrocarbon fluid pump 110 can be driven by the downhole turbine 109.

The upwardly directed hydrocarbon fluid 2010 flows up to the downhole heat exchanger 107 at state E and transfer some heat to the working fluid 2002.

As the upwardly directed hydrocarbon fluid 2010 rises in the downhole heat exchanger 107 to state F, the upwardly directed hydrocarbon fluid 2010 can heat the working fluid 2002 traveling down the downhole heat exchanger 107. In addition, the upwardly directed hydrocarbon fluid 2010 can flow from state F to the surface at state G. Then the upwardly directed hydrocarbon fluid can transfer some heat to the working fluid 2002 flowing down the hydrocarbon well 101 from state 1 to state 2 in a portion of the hydrocarbon well 101, which can be arranged as a counter-current flow “pipe-in-pipe” heat exchanger.

At state G, the upwardly directed hydrocarbon fluid 2010 can exit the hydrocarbon well 101 at a desired pressure for introduction into the tank 2009, which can be in fluid communication with the production zone 113 at state A.

In embodiments, the working fluid 2002 can enter the downhole turbine 109 in a supercritical state and in other physical states that are not supercritical, which can include, for example, single phase and dual phase.

The construction of the hydrocarbon well 101 and the operating environment in which the expander pump unit 108 operates can present a number of design challenges for the expander pump unit 108, in particular, the downhole turbine 109 of the expander pump unit 108.

In an embodiment, the subsurface portion of the hydrocarbon power system 100 can be constructed from modular assemblies, which can be partially assembled at the surface and can be lowered into the hydrocarbon well 101 in a predetermined sequence.

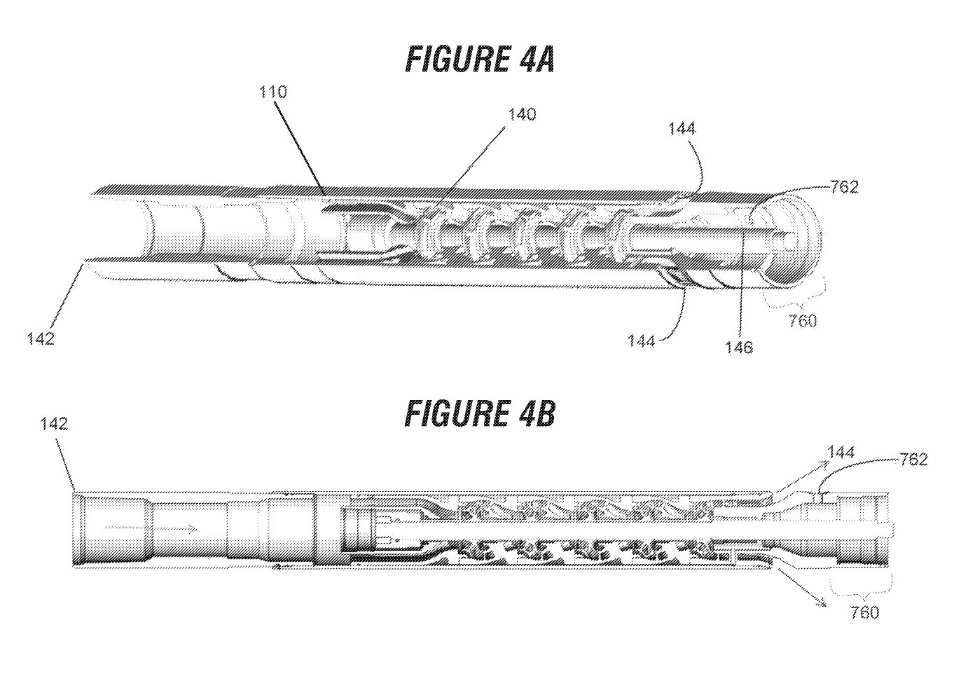

FIG. 4A shows a cutaway view of a hydrocarbon fluid pump according to one or more embodiments. FIG. 4B shows a sectional view through the hydrocarbon fluid pump of FIG. 4A according to one or more embodiments.

Referring to FIG. 4A and FIG. 4B, the hydrocarbon fluid pump 110 can have a plurality of stages 140, which can move fluid axially through the hydrocarbon fluid pump 110 in the direction of the arrow from an inlet 142 of the hydrocarbon fluid pump 110 through the plurality of stages 140 to an exit 144, which can go to the tank.

The hydrocarbon fluid pump 110 can have a pump shaft 146, which can be magnetically coupled to and driven by the downhole turbine.

A coupling section 760 of the hydrocarbon fluid pump 110 can be depicted with the exit 144 as well as a port 762.

Various example embodiments of the downhole turbine are discussed herein below, which are arranged in accordance with an aspect of the invention.

In the following discussion, the phrases “output end” and “output direction” can denote a position and direction toward the surface equipment of the hydrocarbon power system. The phrases “pump end” and “pump direction” can denote a position and a direction toward the pump of the expander pump unit. Also, in the examples that follow, like structures can be denoted by like reference numbers.

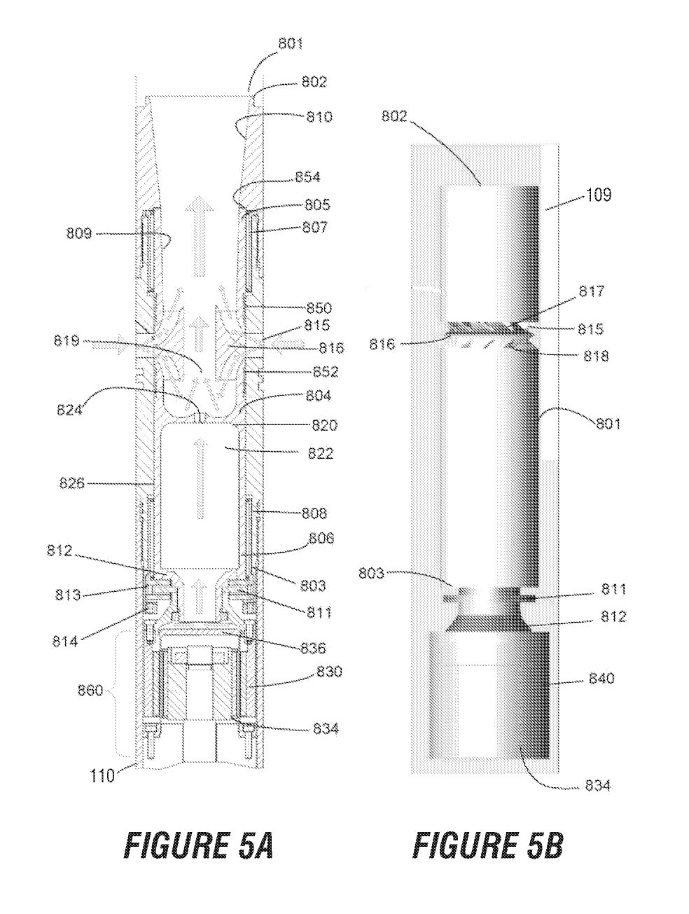

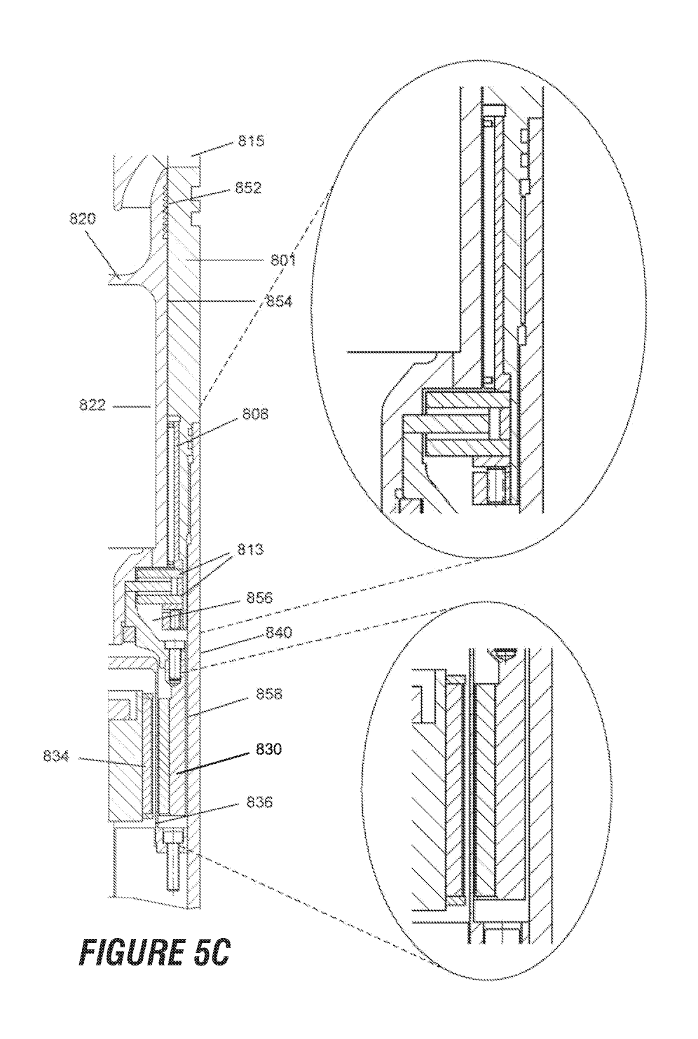

FIG. 5A shows a sectional view of the downhole turbine according to one or more embodiments. FIG. 5B shows a side elevational view of the downhole turbine shown in FIG. 5A according to one or more embodiments. FIG. 5C shows fluid pathways of the downhole turbine according to one or more embodiments.

Referring to FIGS. 5A-5C, the downhole turbine 109 can have the turbine casing 801 extending axially from an outlet end of the turbine casing 802 to a first pump end of the turbine casing 803.

A hydrocarbon pump casing 840 can be attached to the first pump end of the turbine casing 803. A turbine shaft 804 can extend axially within the turbine casing 801 between the outlet end of the turbine shaft 805 and a pump end of the turbine shaft 806.

The turbine shaft 804 can be radially supported by an upper radial bearing 807, which can be a foil bearing, and a lower radial bearing 808, which can be a foil bearing.

Each radial bearing can be at the outlet end of the turbine shaft 805 and the pump end of the turbine shaft 806 respectively, of the turbine shaft 804.

An inner frustoconical surface 809 of the outlet end of the turbine shaft 805 can diverge in the outlet direction, that is, in the direction of the surface, toward a diverging frustoconical inner surface 810 of the turbine casing 801 which can extend to the outlet end of the turbine casing 802. The turbine shaft 804 can be constructed to rotate concentrically within the turbine casing 801.

The turbine shaft 804 can be axially supported by a plurality of thrust bearings 813. An annular thrust plate 811 can extend from a first hub 812, which can be connected to the pump end of the turbine shaft 806.

The annular thrust plate 811 can be positioned between a pair of thrust bearings of the plurality of thrust bearings 813, which can be retained between the lower edge of the turbine shaft 804 and a support 814 extending from an inner wall of the turbine casing 801 at the first pump end of the turbine casing 803.

The upper radial bearing 807 and the lower radial bearing 808 can be employed in the downhole turbine 109, and other bearing types can be used as well. The plurality of thrust bearings 813 and the upper and lower bearings can be constructed to be lubricated by the working fluid passing through the downhole turbine 109, which can eliminate a need for an auxiliary lubrication fluid and an associated lubrication system.

The plurality of thrust bearings 813 can have a limited thrust load carrying capacity. To maintain thrust loads within the load carrying capacity of the plurality of thrust bearings 813, the downhole turbine 109 can be provided with a configuration that can attempt to minimize the resultant thrust load on the plurality of thrust bearings 813 by hydraulically balancing the thrust loads.

The radial circumferential inlet 815 can be formed through the turbine casing 801 leading toward a rotor 816 connected to the turbine shaft 804.

The working fluid can be used to lubricate the plurality of thrust bearings 813, the upper radial bearing 807, and the lower radial bearing 808. A plurality of upper circumferential labyrinth seals 850 and a plurality of lower circumferential labyrinth seals 852, respectively, can be formed circumferentially in the outer surface of the turbine shaft 804 and axially above and below the radial circumferential inlet 815.

The plurality of upper circumferential labyrinth seals 850 and the plurality of lower circumferential labyrinth seals 852 can be constructed to permit a portion of the high pressure working fluid from the radial circumferential inlet 815 to leak between the outer surface of the turbine shaft 804 and the inner surface of the turbine casing 801, which can migrate to the plurality of bearings. The plurality of bearings can be at a lower pressure than the working fluid at the radial circumferential inlet 815.

The turbine shaft 804 can have a chamber 822, which can be cylindrical and below a flange 820, which can have an orifice 824 formed in the flange 820, which fluidly can couple the chamber 822 to a passageway 819.

The chamber 822 can be also defined by a chamber wall 826 of the turbine shaft 804, which can extend axially from the flange 820 toward the pump end of the turbine shaft 806.

The chamber wall 826 can be connected to the first hub 812, which can be attached to the annular thrust plate 811. The first hub 812 can be connected at its opposite end to an outer rotor 830 of the magnetic coupling 860. The magnetic coupling can couple the turbine shaft 804 magnetically to an inner rotor 834 connected to the hydrocarbon fluid pump 110.

Below the radial circumferential inlet 815, between the plurality of lower circumferential labyrinth seals 852 and the lower radial bearing 808, a transverse passage 854 can extend in an annular space 858 between the outer surface of the turbine shaft 804 and the inner surface of the turbine casing 801.

A canister 836 can be located between the inner rotor 834 and the outer rotor 830, which can be fixed to the hydrocarbon pump casing 840. The canister 836 can separate the working fluid in the downhole turbine 109 from the upwardly directed hydrocarbon fluid in the hydrocarbon fluid pump 110.

The radial circumferential inlet 815 can be formed by a circumferential groove formed in the turbine casing 801. The rotor 816 can be constructed to rotate a turbine shaft when the rotor 816 can be impinged by the working fluid entering the downhole turbine 109 through the radial circumferential inlet 815.

In operation, the working fluid can enter the radial circumferential inlet 815 in a supercritical state as described herein above and can impinge on the rotor 816. The working fluid can be then be redirected by the rotor 816 and the inner surface of the turbine shaft 804 and the working fluid can exit at a lower density and pressure through the outlet end of the turbine casing 802.

The rotor 816 can be constructed as a disk having an axially opposed upper impeller 817 and an axially opposed lower impeller 818.

The rotor 816 can include the passageway 819 through its center. An outer edge of the rotor 816 can divide the working fluid towards the axially opposed upper impeller 817 and the axially opposed lower impeller 818. The axially opposed upper impeller 817 can receive a first portion of the working fluid. The axially opposed lower impeller 818 can receive a second portion of the working fluid.

The working fluid impinging on the axially opposed upper impeller 817 can exert forces on the axially opposed upper impeller 817, which can cause the axially opposed upper impeller and the turbine shaft 804 to rotate while the surfaces of the axially opposed upper impeller 817 redirect the working fluid toward the outlet end of the turbine casing 801 of the downhole turbine 109.

The working fluid impinging on the axially opposed lower impeller 818 can also exert forces on the axially opposed lower impeller 818, which can cause the axially opposed lower impeller and the turbine shaft 804 to rotate in the same rotational direction as the axially opposed upper impeller 817.

However, the axially opposed lower impeller 818 can redirect the second portion of the working fluid downwardly in an opposite axial direction than the fluid redirected by the axially opposed upper impeller 817.

The second portion of the working fluid can be redirected in an upward direction by the flange 820 below the axially opposed lower impeller 818. The working fluid redirected from the flange 820 can travel through the center of the rotor 816 toward the outlet end of the turbine casing 802 of the downhole turbine 109.

The axially opposed upper impeller 817 and the axially opposed lower impeller 818 can produce some amount of axial thrust because of different pressures and different geometries on the two sides of the axially opposed upper impeller 817 and the axially opposed lower impeller. The thrust of the axially opposed upper impeller 817 and the axially opposed lower impeller 818 facing in opposite directions can cancel out.

The net thrust exerted on the plurality of thrust bearings can be less than it would be if the axially opposed upper impeller 817 and the axially opposed lower impeller were not opposed, i.e., if both of them faced in the same direction, or if only one them were utilized. Thus, the movement of the working fluid within the downhole turbine 109 in opposite axial directions can contribute to a reduction in residual bearing load on the plurality of thrust bearings 813 within the load carrying capacity of the plurality of thrust bearings 813.

As a result of the thrust bearing load balancing, the plurality of thrust bearings 813 can be a suitable choice because they do not require external lubrication.

Although the axially opposed upper impeller 817 and the axially opposed lower impeller 818 can cancel their thrust forces, other surfaces of the downhole turbine 109 can also result in a net thrust load on the plurality of thrust bearings 813, which can be accounted for and reduced within the capacity of the plurality of thrust bearings 813.

Another component of the thrust load caused by the configuration of the downhole turbine 109 can result from the lubrication arrangements of the upper radial bearing 807, the lower radial bearing 808, and the plurality of thrust bearings 813.

As discussed hereinabove the working fluid can be used to lubricate the plurality of thrust bearings 813, the upper radial bearing 807, and the lower radial bearing 808. The plurality of upper circumferential labyrinth seals 850 and the plurality of lower circumferential labyrinth seals 852, respectively, can be formed circumferentially in the outer surface of the turbine shaft 804 and axially above and below the radial circumferential inlet 815. The plurality of upper circumferential labyrinth seals 850 and the plurality of lower circumferential labyrinth seals 852 can be constructed to permit a portion of the working fluid from the radial circumferential inlet 815 to leak between the outer surface of the turbine shaft 804 and the inner surface of the turbine casing 801, which can then migrate to the plurality of bearings. The plurality of bearings can be at a lower pressure than the working fluid 2002 at the radial circumferential inlet 815.

The turbine shaft 804 can be axially supported by plurality of thrust bearings 813. The annular thrust plate 811 can extend from the first hub 812, which can be connected to the pump end of the turbine shaft 806.

The performance of the magnetic coupling 860 can be affected by the operating temperature of the working fluid therein. For example, performance, measured in terms of slip torque, can be adversely affected by as much as twelve percent as a result of operating at elevated operating temperatures in the hydrocarbon well 101. To reduce performance losses in transferring input torque from the outer rotor 830 to the inner rotor 834, the upwardly directed hydrocarbon fluid can be used to cool the region 856 between the canister 836 and the inner rotor 834.

Although the canister 836 can separate the upwardly directed hydrocarbon fluid from the working fluid, use of the canister 836 can contribute to efficiency losses of the magnetic coupling 860. Losses from the canister 836 can manifest as eddy current losses and losses caused by viscous drag forces (sometimes referred to as windage losses). The material composition of the canister 836 can affect eddy currents, since flux lines of the magnetic coupling 860 pass through the non-rotating canister material. Moreover, conductive materials used for the canister 836 can start to heat as the rotational speed of the outer rotor 830 and the inner rotor 834 increases.

The canister 836 materials can lead to resistance of the coupling motion, as some of the input work can be converted into eddy current losses in the form of heat. At higher rotor speeds, the eddy current losses cannot be negligible. Another inefficiency of the magnetic coupling 860 can be caused by viscous drag forces, losses which have been determined to be less than the eddy current losses.

As shown in greater detail in FIG. 5C, a working fluid pathway can exist from the plurality of lower circumferential labyrinth seals 852 to the chamber 822 through the lower radial bearing 808 and the plurality of thrust bearings 813.

The transverse passage 854 can extend in the annular space 858 between the outer surface of the turbine shaft 804 and the inner surface of the turbine casing 801.

The path can continue through the lower radial bearing 808 and extend down to the region 856 surrounding the plurality of thrust bearings 813. The path can continue in the annular space 858 between the outer rotor 830 and the hydrocarbon pump casing 840.

The path then can turn around the lower edge of the outer rotor 830 and extend in the annular space 858 between the canister 836 and the inner surface of the outer rotor 830.

The path then can extend between a gap between the first hub 812 and the canister 836, and then through the first hub 812 and into the chamber 822. The working fluid pressure exerted on the first hub 812 and the lower edge of the outer rotor 830, for example, can produce an upward thrust on the turbine shaft 204.

The working fluid exiting the chamber 822, being at higher relative pressure to the fluid, can be redirected from the axially opposed lower impeller 818. The working fluid can continue its path through the orifice 824 in the flange 820 through the passageway 819 of the turbine rotor 816.

The leakage flow rate through the plurality of lower circumferential labyrinth seals 852 can be based on the construction of the plurality of upper circumferential labyrinth seals 852, the pressure differential between the inlet pressure of the working fluid at the radial circumferential inlet 815, and the pressure of the working fluid at the exit of the axially opposed lower impeller 818.

Accordingly, the amount of leakage flow through the lower radial bearing 808 and the plurality of thrust bearings 813 can be adjusted based on the construction of the plurality of lower circumferential labyrinth seals 852. Such adjustment of the flow rate through the plurality of lower circumferential labyrinth seals 852 therefore can also adjust the thrust force due to the flow path of the working fluid in the lubrication path.

The plurality of upper circumferential labyrinth seals 850 can be formed circumferentially in the outer surface of the turbine shaft 804 above the radial circumferential inlet 815.

An annular leakage path can be formed between the outer surface of the turbine shaft 804 and the inner surface of the turbine casing 801 and can extend axially between the plurality of upper circumferential labyrinth seals 850 and the upper radial bearing 807 to the outlet end of the turbine shaft 805.

The leakage path can continue through the transverse passage 854 formed between the edge of the outlet end of the turbine shaft 805 and the surface of the turbine casing 810. The transverse passage 854 can extend to the outlet end of the turbine casing 802 where the working fluid pressure can be lower than at the radial circumferential inlet 815, thus providing a pressure differential to drive the leakage flow.

FIG. 5C shows details that can address some of the performance considerations caused by the arrangement of the magnetic coupling 860 at the operating speed of the hydrocarbon fluid pump 110. A portion of the duty flow of the hydrocarbon fluid pump 110 can be diverted to the region between the inner rotor 834 and the canister 836 for cooling the magnetic coupling 860. The magnetic coupling 860 can be housed in the coupling section 760 of the hydrocarbon fluid pump 110 shown in FIGS. 4A and 4B.

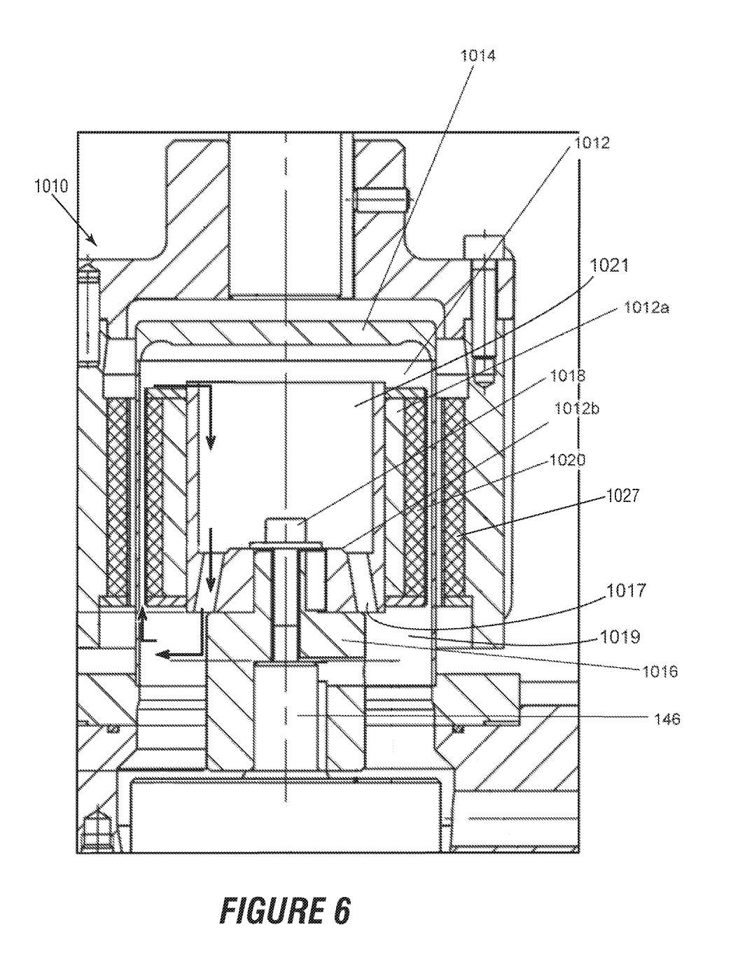

FIG. 6 shows a magnetic coupling according to one or more embodiments.

In this embodiments, the inner rotor 1012 can be constructed of a cylindrical wall 1012a attached to a base 1012b.

The base 1012b can be seated on a second hub 1016 which can be seated on the end of the pump shaft 146.

The base 1012b and the second hub 1016 can have concentric openings through which a fastener 1018 can extend to fasten the inner rotor 1012 to the end of the pump shaft 146. A pump magnet can be attached to the cylindrical wall 1012a on its outer surface facing a canister 1014.

A turbine magnet 1027 can be opposite the pump magnet 1020.

A working fluid pathway can be defined, represented by solid arrows, in which the upwardly directed hydrocarbon fluid can flow in the magnetic coupling 1010 on the hydrocarbon fluid-side of the canister 1014.

A portion of the discharged high pressure of the upwardly directed hydrocarbon fluid can flow into a region 1019 defined by the canister 1014, the second hub 1016, and the base 1012b. The upwardly directed hydrocarbon fluid can circulate generally clockwise around the cylindrical wall 1012a of the inner rotor 1012 in the direction of the arrows.

In one embodiment, the upwardly directed hydrocarbon fluid can enter the magnetic coupling 1010 through an opening in the pump housing such as through the port and can move to the region 1019. In one embodiment, the structure of the magnetic coupling 1010 can be constructed to dissipate heat from the upwardly directed hydrocarbon fluid circulating in the inner rotor 1012. In one embodiment, the heat dissipation can be sufficient to mitigate renewing the upwardly directed hydrocarbon fluid in the inner rotor 1012.

The magnetic coupling 1010 can include the canister 1014 interposed between the turbine magnet 1027 and the pump magnet 1020. In embodiments, the canister 1014 can be non-magnetic. The canister 1014 can separate the upwardly directed hydrocarbon fluid from the working fluid.

The upwardly directed hydrocarbon fluid in a cavity 1021 can be defined by the cylindrical wall 1012a and can move downward through a plurality of diagonal openings 1017. When rotating with the pump shaft 146, the plurality of diagonal openings can act as a pump stage and can push the upwardly directed hydrocarbon fluid to the region 1019. The upwardly directed hydrocarbon fluid can then move between the canister 1014 and the outer surface of the cylindrical wall 1012a, whereupon it can return to the cavity 1021.

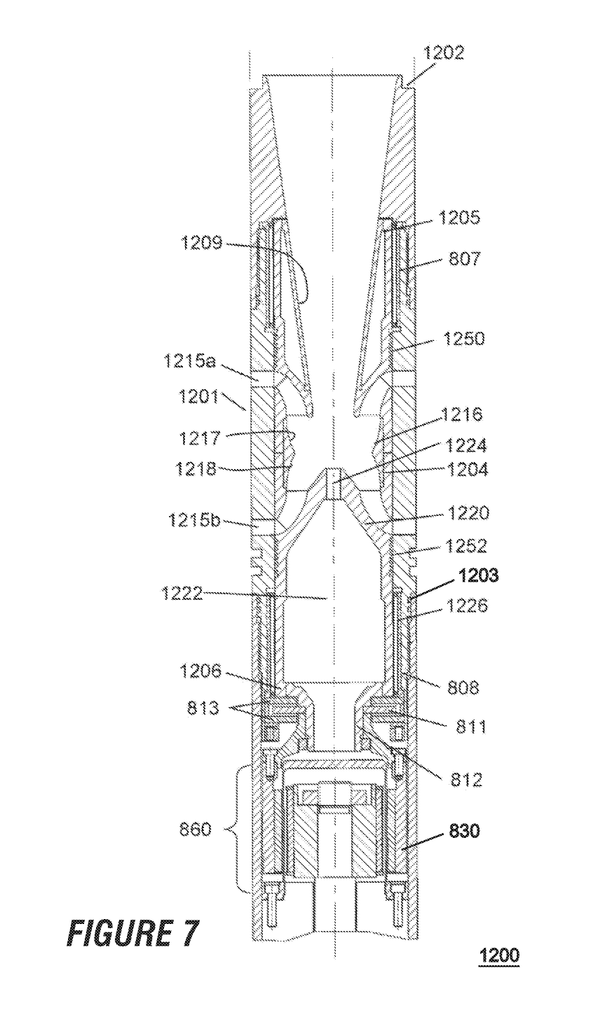

FIG. 7 is a cross sectional view of the downhole turbine according to one or more embodiments.

In this embodiment, the downhole turbine 1200 can include a turbine casing 1201 extending axially from an outlet end of the turbine casing 1202 to a pump end of the turbine casing 1203.

A turbine shaft 1204 can be inside the turbine casing 1201 extending coaxially with the turbine casing 1201.

The turbine shaft 1204 can also have an outlet end of the turbine shaft 1205 and a pump end of the turbine shaft 1206.

The turbine shaft 1204 can be supported radially by the upper radial bearing 807 and the lower radial bearing 808 between the turbine shaft 1204 and the turbine casing 1201. The upper radial bearing 807 and the lower radial bearing 808 can be disposed in annular grooves formed in the inner surface of the turbine casing 1201.

The upper radial bearing 807 and the lower radial bearing 808 can be positioned at the outlet end of the turbine shaft 1205 and the pump end of the turbine shaft 1206, respectively, of the turbine shaft. The turbine shaft 1204 can be axially supported by the plurality of thrust bearings 813 at the pump end of the turbine shaft 1206 of the turbine shaft 1204.

The turbine shaft 1204 can be constructed to rotate within the turbine casing 1201 when the working fluid enters the downhole turbine 1200 through an upper circumferential inlet 1215a and a lower circumferential inlet 1215b formed in the turbine casing 1201. The working fluid can impinge on a rotor 1216.

The turbine shaft 1204 can have the inner frustoconical surface that can expand radially in the outlet direction between the rotor 1216 and the outlet end of the turbine shaft 1205. The outer surface of the turbine shaft 1204 between the rotor 1216 and the outlet end of the turbine shaft 1205 can be cylindrical and can be partially surrounded by the upper radial bearing 807.

The upper radial bearing 807 can extend axially from the outlet end of the turbine shaft 1205 in a direction towards a plurality of upper circumferential labyrinth seals 1250, which can be formed in the outer surface of the turbine shaft 1204 above the upper circumferential inlet 1215a.

The upper radial bearing 807 can be received in an annular groove formed in the inner surface of the turbine casing 1201 around the outlet end of the turbine shaft 1205.

The upper circumferential inlet 1215a and the lower circumferential inlet 1215b can be axially spaced across the rotor 1216. The rotor 1216 can have an axially opposed upper impeller 1217 and an axially opposed lower impeller 1218, respectively, formed in the wall of the turbine shaft 1204.

An inner frustoconical surface 1209 of the turbine shaft 1204 can be directly above the rotor 1216, and can extend axially down and beyond the upper circumferential inlet 1215a. The inner frustoconical surface 1209 of the turbine shaft 1204 can have a curved surface, which can redirect the working fluid entering the upper circumferential inlet 1215a in the downward direction toward the axially opposed upper impeller 1217.

The redirection of the working fluid downward toward the axially opposed upper impeller 1217 can act to reduce the resultant thrust load on the plurality of thrust bearings 813. The working fluid can impinge on the axially opposed upper impeller 1217 and can rotate the rotor 1216 and the turbine shaft 124.

Similar to the chamber previously described, the turbine in this Figure can also include a chamber 1222, which can be a pump end of the chamber and below the rotor 1216, defined by a flange 1220 and the cylindrical wall 1226.

The flange 1220 of the chamber 1222 can protrude axially upward beyond the lower circumferential inlet 1215b and can form a curved surface, which can redirect the working fluid entering the lower circumferential inlet 1215b in an upward direction toward the axially opposed lower impeller 1218. The upwardly directed hydrocarbon fluid can impinge on the axially opposed lower impeller 1218 and rotate the rotor 1216 and the turbine shaft 1204.

The chamber 1222 can be attached to the first hub 812 which can be attached to the outer rotor 830 of the magnetic coupling 860.

Accordingly, the chamber 1222 can be arranged in the same manner as the downhole turbine 1200.

Moreover, the upper radial bearing 807, the lower radial bearing 808, and the plurality of thrust bearings 813 can be lubricated in the same manner as the corresponding elements of the downhole turbine 1200.

The upper radial bearings 807, the lower radial bearings 808, and the plurality of thrust bearings 813 of the downhole turbine 1200 can receive the working fluid that leaks past the plurality of upper circumferential labyrinth seals 1250 and a plurality of lower circumferential labyrinth seals 1252 due to a pressure differential between the working fluid pressure at the lower circumferential inlet and the upper circumferential inlet 1215a and the lower circumferential inlet 1215b and the working fluid pressure at the upper radial bearing 807, the lower radial bearing 808, and the plurality of thrust bearings 813.

The working fluid passing the lower radial bearing 808 can also return into the chamber 1222 and can be expelled from the chamber 1222 through an orifice 1224 in the flange 1220 in the same manner as the working fluid expelled through the orifice in connection with the downhole turbine 1200.

The turbine shaft 804 can be axially supported by the plurality of thrust bearings 813. The annular thrust plate 811 can extend from the first hub 812, which can be connected to the pump end of the turbine shaft 806.

With reference to all the Figures, in an embodiment, the hydrocarbon power system 100 for a hydrocarbon well 101 can have the power plant 102 structured to receive the working fluid 2002 and to drive at least one of: at least one surface located electric generator 2004, the surface located pump 2006, and a surface located compressor 2008.

The hydrocarbon power system 100 can have the downhole heat exchanger 107 in the hydrocarbon well 101 structured to transfer heat from the upwardly directed hydrocarbon fluid 2010 to the working fluid 2002.

The hydrocarbon power system 100 can have the expander pump unit 108 with the downhole turbine 109 coupled to the hydrocarbon fluid pump 110.

In embodiments, the expander pump unit 108 can be removably disposed downhole in the hydrocarbon well 101, and the hydrocarbon fluid pump 110 can be in fluid communication with the downhole heat exchanger 107 for pumping the upwardly directed hydrocarbon fluid 2010 toward the surface 112.

In embodiments, the downhole turbine 109 can be in fluid communication with the downhole heat exchanger 107 and the power plant 102 so as to receive the working fluid 2002 from the power plant 102 through the annular space 2021 between the outer pipe 2020 and the inner pipe 2022 in the hydrocarbon well 101 and to return the working fluid 2002 to the power plant 102.

The downhole turbine 109 can include the turbine shaft 804 rotatably supported by the turbine casing 801 and coaxial with the hydrocarbon well 101, the rotor 816 coupled to the turbine shaft 804, wherein the rotor 816 can be structured to receive the working fluid 2002 from the downhole heat exchanger 107 and to redirect the working fluid 2002 to flow in opposed axial directions, the upper radial bearing 807, the lower radial bearing 808, and the plurality of thrust bearings 813, supporting the turbine shaft 804.

The plurality of bearings can be disposed between the turbine shaft 804 and the turbine casing 801. The plurality of bearings can be lubricated by the working fluid 2002.

In embodiments, the radial circumferential inlet 815 can be formed through the turbine casing 801.

In embodiments, the radial circumferential inlet 815 can be constructed to direct the working fluid 2002 to the rotor 816. The turbine shaft 804 can be constructed to direct the working fluid 2002 redirected by the rotor towards the power plant 102.

In some instances, the hydrocarbon power system can have a radial circumferential inlet 815 and can be axially spaced from an upper circumferential inlet 1215a by the rotor.

In embodiments, the hydrocarbon power system can use at least one thrust bearing of the plurality of bearings 813, the upper radial bearing 807, and the lower radial bearing 808 simultaneously.

In embodiments, the rotor 816 can be constructed to redirect at least a portion of the working fluid 2002 to minimize a resultant axial thrust load on the plurality of thrust bearings 813.

In embodiments, the working fluid 2002 received by the downhole turbine 109 can be in a single phase state or a supercritical state.

In embodiments, the working fluid 2002 can include at least one of: a hydrocarbon alkane, a hydrofluorocarbon refrigerant, or both.

In embodiments, the turbine shaft 804 can be constructed to permit the working fluid 2002 to leak from the radial circumferential inlet 815 between the turbine shaft 804 and the turbine casing 801 to the plurality of bearings.

In embodiments, the turbine shaft 804 can include a plurality of circumferential upper labyrinth seals 850 and a plurality of lower circumferential labyrinth seals 852 axially spaced by the radial circumferential inlet 815 such that the working fluid 2002 can be permitted to leak.

In embodiments, the downhole heat exchanger 107 can be within the well casing 2025. The upwardly directed hydrocarbon fluids 2010 can flow upward between the well casing 2025 and the outer pipe 2020 to heat the working fluid 2002 flowing downward.

While these embodiments have been described with emphasis on the embodiments, it should be understood that within the scope of the appended claims, the embodiments might be practiced other than as specifically described herein.

What is claimed is:

1. A hydrocarbon power system for a hydrocarbon well, the hydrocarbon power system comprising:
a. a power plant structured to receive a working fluid and to drive at least one of: at least one surface located electric generator, a surface located pump, and a surface located compressor;
b. a downhole heat exchanger in the hydrocarbon well structured to transfer heat from an upwardly directed hydrocarbon fluid to the working fluid; and
c. an expander pump unit comprised of a downhole turbine coupled to a hydrocarbon fluid pump, the expander pump unit removably disposed downhole in a well, the hydrocarbon fluid pump being in fluid communication with the downhole heat exchanger for pumping the upwardly directed hydrocarbon fluid toward a surface, the downhole turbine being in fluid communication with the downhole heat exchanger and the power plant so as to receive the working fluid from the power plant through an annular space between an outer pipe and an inner pipe in the hydrocarbon well and to return the working fluid to the power plant, wherein the downhole turbine includes:
(i) a turbine shaft rotatably supported by a turbine casing and coaxial with the hydrocarbon well;
(ii) a rotor coupled to the turbine shaft, wherein the rotor is structured to receive the working fluid from the downhole heat exchanger and to redirect the working fluid to flow in opposed axial directions; and
(iii) a plurality of bearings supporting the turbine shaft, the plurality of bearings disposed between the turbine shaft and the turbine casing, the plurality of bearings lubricated by the working fluid, wherein a radial circumferential inlet is formed through the turbine casing, the radial circumferential inlet constructed to direct the working fluid to the rotor; and
wherein the turbine shaft is constructed to direct the working fluid redirected by the rotor towards the power plant.

2. The hydrocarbon power system of claim 1, wherein the radial circumferential inlet is axially spaced from an upper circumferential inlet by the rotor.

3. The hydrocarbon power system of claim 1, wherein the plurality of bearings include at least one of: a plurality of thrust bearings, an upper radial bearing, and a lower radial bearing.

4. The hydrocarbon power system of claim 3, wherein the rotor is constructed to redirect at least a portion of the working fluid to minimize a resultant axial thrust load on the plurality of thrust bearings.

5. The hydrocarbon power system of claim 1, wherein the working fluid received by the downhole turbine is in a single phase state or a supercritical state.

6. The hydrocarbon power system of claim 1, wherein the working fluid includes at least one of: a hydrocarbon alkane, a hydrofluorocarbon refrigerant, and both the hydrocarbon alkane and the hydrofluorocarbon refrigerant.

7. The hydrocarbon power system of claim 1, wherein the turbine shaft is constructed to permit the working fluid to leak from the radial circumferential inlet between the turbine shaft and the turbine casing to the plurality of bearings.

8. The hydrocarbon power system of claim 7, wherein the turbine shaft includes a plurality of upper circumferential labyrinth seals and a plurality of lower circumferential labyrinth seals axially spaced by the radial circumferential inlet such that the working fluid is permitted to leak.

9. The hydrocarbon power system of claim 1, wherein the downhole heat exchanger is within a well casing and wherein the upwardly directed hydrocarbon fluid flows upward between the well casing and the outer pipe to heat the working fluid flowing downward.

10. An expander pump unit for the hydrocarbon power system, comprising:
a. a downhole turbine disposed downhole in a hydrocarbon well, the downhole turbine constructed to receive a working fluid flowing downward from a terrestrial surface region and expand the working fluid to the terrestrial surface region, wherein the downhole turbine includes:
(i) a turbine casing;
(ii) a turbine shaft rotatably coupled to the turbine casing;
(iii) a plurality of bearings between the turbine casing and the turbine shaft for supporting the turbine shaft in the turbine casing, the plurality of bearings lubricated by the working fluid,
(iv) a rotor coupled to the turbine shaft; and
(v) a radial circumferential inlet formed around the rotor and constructed for delivering the working fluid to the rotor; and
wherein the rotor is constructed to redirect the working fluid received from the radial circumferential inlet in at least two opposed axial directions, and further wherein the turbine shaft is constructed to direct the working fluid redirected by the rotor towards a surface;
b. a hydrocarbon fluid pump comprising a plurality of stages, each stage of the plurality of stages moving an upwardly directed hydrocarbon fluid axially through the hydrocarbon fluid pump in a single direction from an inlet through the plurality of stages to an exit; and
c. a magnetic coupling magnetically connecting the downhole turbine to the hydrocarbon fluid pump.

11. The expander pump unit of claim 10, wherein the turbine shaft is axially supported by a plurality of thrust bearings between the turbine shaft and the turbine casing and wherein the rotor is constructed to redirect the working fluid to minimize the resultant axial thrust load on the plurality of thrust bearings.

12. The expander pump unit of claim 11, wherein the plurality of thrust bearings are lubricated by the working fluid.

13. The expander pump unit of claim 10, wherein the magnetic coupling comprises a turbine magnet and a pump magnet.

14. The expander pump unit of claim 13, wherein the magnetic coupling includes a canister interposed between the turbine magnet and the pump magnet, wherein the canister is non-magnetic as the canister separates the upwardly directed hydrocarbon fluid from the working fluid.

15. The expander pump unit of claim 10, wherein the turbine shaft is radially supported by an upper radial bearing and a lower radial bearing comprising foil bearings.

16. The expander pump unit of claim 11, wherein the plurality of thrust bearings are disposed between the rotor and the hydrocarbon fluid pump.

17. The expander pump unit of claim 10, wherein the turbine shaft includes a plurality of circumferential upper labyrinth seals and a plurality of circumferential lower labyrinth seals axially spaced proximate to the radial circumferential inlet such that the working fluid is permitted to leak on the plurality of bearings.

18. A downhole turbine for use downhole in a hydrocarbon well of a hydrocarbon power system, the downhole turbine comprising:
a. a turbine casing;
b. a turbine shaft rotatably coupled to the turbine casing;
c. a plurality of bearings between the turbine casing and the turbine shaft for supporting the turbine shaft in the turbine casing, the plurality of bearings lubricated by a working fluid;
d. a rotor coupled to the turbine shaft; and
e. a radial circumferential inlet formed around the rotor and constructed for delivering the working fluid to the rotor; and
wherein the rotor is constructed to redirect the working fluid received from the radial circumferential inlet in at least two opposed axial directions, and further wherein the turbine shaft is constructed to direct the working fluid redirected by the rotor axially in a direction toward a surface.

19. The downhole turbine of claim 18, wherein the rotor includes an axially opposed upper impeller and an axially opposed lower impeller to redirect the working fluid in at least two opposite axial directions.
